(19) United States
(12) Patent Application Publication
(10) Pub. No.: US 2006/0191971 A1
(43) Pub. Date: Aug. 31, 2006

(54) Nail restrainer and a nailing machine equipped with said restrainer

(76) Inventor: Xiaorong Li, Zhejiang (CN)

Correspondence Address: KAPLAN GILMAN GIBSON & DERNIER L.L.P., 900 ROUTE 9 NORTH, WOODBRIDGE, NJ, 07095, US

(21) Appl. No.: 10/545,369

(22) PCT Filed: Apr. 17, 2003
(86) PCT No.: PCT/CN03/00279

§ 371 Date: Aug. 12, 2005

(30) Foreign Application Priority Data
Feb. 25, 2003 (CN) 03204610.3

(51) Int. Cl. B25C 3/00

(52) U.S. Cl. 227/107

(57) ABSTRACT

An improved nail restrainer for a nailing machine comprises a nose located in the front of the nailing machine and a nose cover coupled with the nose. In the nose, there are formed a through hole allowing staples or straight nails to pass therethrough and a guiding groove allowing the staples or straight nails to slide therealong. An elastic rib is provided on the nose cover and extends into said guiding groove, one end of which is integral with the nose cover body. In the present invention, because of the integral structure between the elastic rib and nose cover, it is much easier to be manufactured, the bend extent of the elastic rib is easy to be controlled, and therefore the rejection rate is lowered. Moreover, as no assembling procedure for the elastic rib is needed, the cost is cut down.

### FIELD OF THE INVENTION

The present invention relates to an improved nail restrainer and a nailing machine equipped with said restrainer.

### BACKGROUND OF THE INVENTION

In prior art, in order to get better performance to nail straight nails and staples, most nailing machines are equipped with a nail restrainer for restraining both straight nails and staples, so that the nailing machines can work for different kinds of nails. In general, the nail restrainer for the dual-purpose nailing machine comprises three separate components, namely: nose cover, elastic rib and nose. The elastic rib is connected to the nose cover through a connecting member. For instance, Chinese Utility Model patent No. 01270742.2 discloses a nail restrainer which comprises a nose and a separable nose cover which is locked onto the nose. On the nose cover, there is an elastic rib, one end of which is pivotally coupled to the nose cover. The elastic rib is placed in a nail slot to restrain the nails. As the elastic rib is separable from the nose cover, there exist some shortcomings during production, such as: it is difficult to control the bend extent of the elastic rib and the rejection rate is very high. Moreover, it adds an extra step of assembling the elastic rib.

### SUMMARY OF THE INVENTION

The object of present invention is to overcome the disadvantages of the above-mentioned prior art, and to provide an improved nail restrainer and a nailing machine equipped with such restrainer. This nail restrainer is much easier to be manufactured and has a lower rejection rate.

The nail restrainer according to the present invention comprises a nose located in the front of the nailing machine and a nose cover coupled with the nose. In the nose, there are a through hole allowing staples or straight nails to pass therethrough and a guiding groove allowing the staples or straight nails to slide therealong. An elastic rib is provided on the nose cover and extends into the guiding groove, and one end of the elastic rib is integral with the nose cover body.

As the elastic rib is integral with the nose cover, the nail restrainer according to the present invention is easier to be manufactured, the bend extent of the rib is easier to be controlled, and therefore the rejection rate is lowered. Moreover, as no assembling procedure for the elastic rib is needed in the present invention, the cost is cut down.

### DESCRIPTION OF THE DRAWINGS

FIG. 1 is a schematic diagram of the nail restrainer for a nailing machine in prior art.

FIG. 2 is a front view of the nose cover and elastic rib of the improved nail restrainer according to the present invention.

FIG. 3 is a cross sectional view along the line A-A of FIG. 2 showing the nose cover and the rib.

FIG. 4 is a front view of the nose of the improved nail restrainer according to the present invention.

FIG. 5 is an exploded view showing the improved nail restrainer according to the present invention.

### EMBODIMENTS

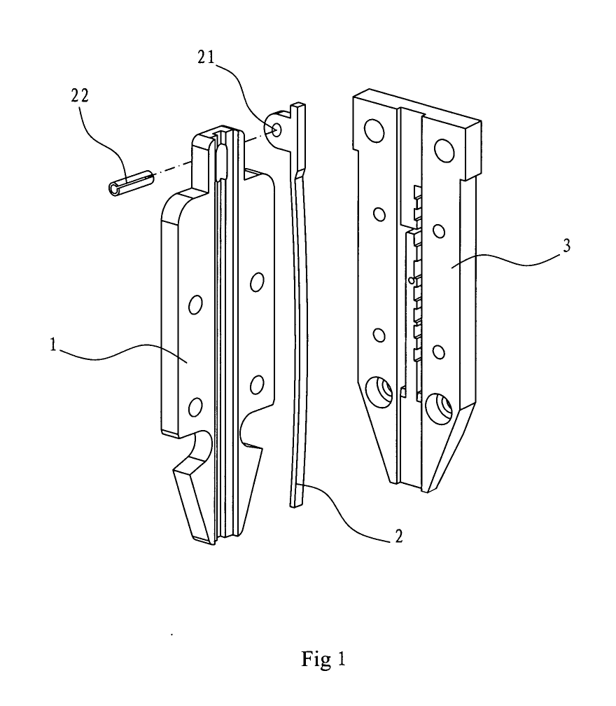

Referring to FIG. 1, a nail restrainer in prior art is illustrated, which comprises three separate components, namely: nose cover 1, elastic rib 2 and nose 3. There is a pivot hole 21 in one end of the elastic rib 2 and this end of the elastic rib 2 is connected with the nose cover 1 by an elastic cylindrical straight pin 22. On the other end of the elastic rib 2, there is a protruding part which extends into the guiding groove of the nose 3. During manufacture, it is difficult to control the bend extent of the protruding part of the elastic rib 2 and the rejection rate is very high.

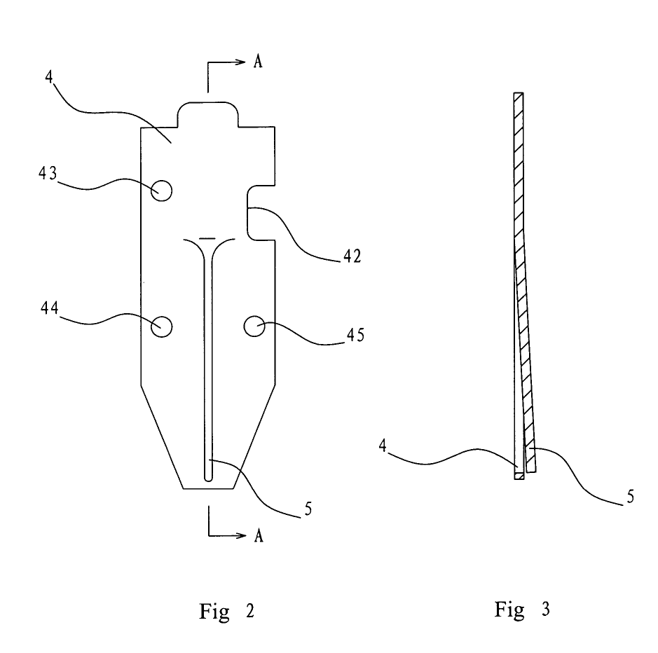

Referring to FIGS. 2˜5, an improved nail restrainer according to the present invention comprises a nose 3 located in the front of the nailing machine and a nose cover 4 coupled with the nose 3. Assembling of the nose 3 and a nailing machine is realized by conventional techniques, and therefore is not described here. In the nose 3 there are formed a through hole 31 allowing staples or straight nails to pass therethrough and a guiding groove 32 allowing the staples or straight nails to slide therealong. An elastic rib 5 is provided on the nose cover 4 and extends into the guiding groove 32. Different from the prior art, in present invention one end of the elastic rib 5 is integral with the body of the nose cover 4.

Referring FIGS. 2 and 3, the structures of the nose cover 4 and the elastic rib 5 are illustrated. The elastic rib 5 is formed as a part of the nose cover 4. It is a tongue-shaped element of a constant width made through cutting and stamping processes. The elastic rib 5 inclines gradually towards the guiding groove 32 from its connected end to its free end. A head of the free end is arc in shape and protrudes from the nose cover 4.

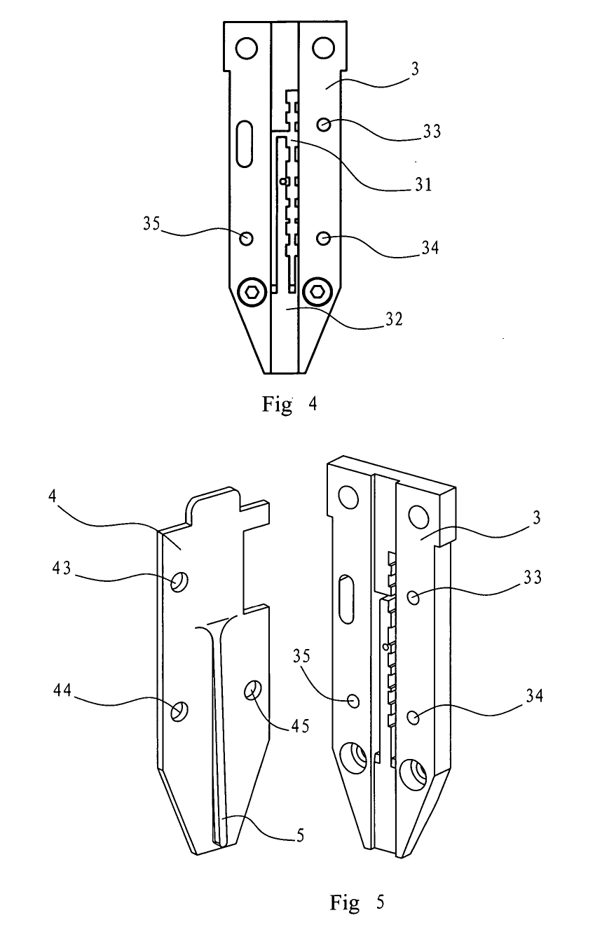

As shown in FIG. 4, the structure of the nose 3 is illustrated, in the nose 3 there is formed a guiding groove 32 allowing staples or straight nails to slide therealong. The through hole 31 is a U-shaped hole formed inside the groove 32, so that the staples can pass therethrough. On one side of the U-shaped through hole there are a plurality of T-shaped through holes allowing straight nails of various models to pass therethrough.

As shown in FIG. 5, there are a plurality of through holes 43, 44 and 45 in the nose cover 4 and there are a plurality of through holes 33, 34 and 35 in the nose 3. The through holes 43, 44 and 45 correspond to the holes 33, 34 and 35 on a one-to-one basis. The nose cover 4 and the nose 3 are fixed together by bolts which pass through the through holes 43, 44 and 45 and the through holes 33, 34 and 35, such that the elastic rib 5 extends into the guiding groove 32 and divides the width of the groove into two portions, on each side, the width shall at least be large enough to allow straight nails or one side of staples to pass therethrough. On one side of the nose cover 4, there is formed a recessed portion 42 for facilitating installation of a safety stand. As the installation of the safety stand is of conventional technology, it is not described here.

As shown in FIGS. 2˜5, the function of the elastic rib 5 in the nailing machine is as follows: When the nailing machine is not in operation, the elastic rib 5 always presses against the middle part of the guiding groove 32 of the nose 3. While nailing straight nails, the nail feeder feeds straight nails into guiding groove 32 through one side of the elastic rib 5. In this case, the elastic rib serves as a directional guide. While nailing staples, the nail feeder feeds staples into the guiding groove 32 through the staple slot. During the nailing operation, the striker pushes away the elastic rib 5 and drives out the staple or straight nail. During this period, the elastic rib 5 remains pressing against the striker.

Apparently, those skilled in the art can use the improved nail restrainer according to present invention to form various kinds of nailing machines.

The above embodiment is used to explain the present invention only, and not to limit the interpretation of this invention. It will be understood by those skilled in the art that various changes in form and details are possible without departing from the spirit and scope of the present invention as defined by claims.

1. An improved nail restrainer for a nailing machine comprising:
a nose (3) located in the front of the nailing machine, in which there are formed a through hole (31) allowing stapes or straight nails to pass therethrough and a guiding groove (32) allowing said staples or straight nails to slide therealong;
a nose cover (4) coupled with said nose;
an elastic rib (5) provided on said nose cover (4) and extending into said guiding groove (32); wherein one end of said elastic rib (5) is integral with the body of said nose cover (4).

2. An improved nail restrainer for a nailing machine according to claim 1, wherein said elastic rib (5) is a tongue-shaped element of a constant width.

3. An improved nail restrainer for a nailing machine according to claim 1, wherein said elastic rib (5) inclines gradually towards said guiding groove (32) from its connected end to its free end, and said free end protrudes from the body of said nose cover (4).

4. An improved nail restrainer for a nailing machine according to claim 1, wherein a head of said free end of said elastic rib (5) is arc in shape.

5. An improved nail restrainer for a nailing machine according to claim 1, wherein there are a plurality of through holes (43, 44 and 45) in said nose cover (4), and there are a plurality of through holes (33, 34 and 35) which correspond to said through holes (43, 44 and 45) in said nose (3).

6. An improved nail restrainer for a nailing machine according to claim 1, wherein there is a recessed portion (42) formed at one side of said nose cover (4).

7. A nailing machine having an improved nail restrainer, said nail restrainer comprising:
a nose (3) located in the front of the nailing machine, in which there are formed a through hole (31) allowing staples or straight nails to pass therethrough and a guiding groove (32) allowing said staples or straight nails to slide therealong;
a nose cover (4) coupled with said nose;
an elastic rib (5) provided on said nose cover (4) and extending into said guiding groove (32);
wherein one end of said elastic rib (5) is integral with said nose cover (4).

8. A nailing machine according to claim 7, wherein said elastic rib (5) is a tongue-shaped element of a constant width.

9. A nailing machine according to claim 7, wherein said elastic rib (5) inclines gradually towards said guiding groove (32) from its connected end to its free end, and said free end protrudes from said nose cover (4).

10. A nailing machine according to claim 7, wherein a head of said free end of said elastic rib (5) is arc in shape.

11. A nailing machine according to claim 7, wherein there are a plurality of through holes (43, 44 and 45) in said nose cover (4), and there are a plurality of through holes (33, 34 and 35) which correspond to said through holes (43, 44 and 45) in said nose (3).

12. A nailing machine according to claim 7, wherein there is a recessed portion (42) formed at one side of said nose cover (4).
